(19) United States
(12) Patent Application Publication
(10) Pub. No.: US 2018/0113099 A1
(43) Pub. Date: Apr. 26, 2018

(54) A VOID FREE INCLUSION-BASED REFERENCE STANDARD FOR NONDESTRUCTIVE TESTS AND METHOD OF MAKING

(71) Applicant: HONEYWELL INTERNATIONAL INC., Morris Plains, NJ (US)

(72) Inventors: Suresh SUNDARRAJ, West Richland, WA (US); Michael R. PINTER, Spokane, WA (US); Michael D. PAYTON, Spokane Valley, WA (US); Mark H. ALBERT, Spokane Valley, WA (US); Stephen P. TURNER, Moon Township, PA (US); Donald M. DEDERICK, Spokane Valley, WA (US)

(73) Assignee: HONEYWELL INTERNATIONAL INC., Morris Plains, NJ (US)

(21) Appl. No.: 15/522,279

(22) PCT Filed: Jun. 30, 2016
(86) PCT No.: PCT/US2016/040386

§ 371 Date: Apr. 26, 2017

Related U.S. Application Data
(60) Provisional application No. 62/191,145, filed on Jul. 10, 2015.

(51) Int. Cl. G01N 29/30; G01N 29/07; G01N 29/06

(52) U.S. Cl. CPC G01N 29/30; G01N 29/075; G01N 2291/044; G01N 2291/012; G01N 29/0645

(57) ABSTRACT

A reference standard for calibrating an ultrasonic scanning apparatus comprising a first portion comprising a first material, a first face, and a second face opposite the first face. The reference standard also has a second portion comprising a second material, a first face, and a second face opposite the first face. The second face of the second portion is adjacent the first face of the first portion and forms an interface. The reference standard also includes a reference material extending axially through the first face of the first portion and the second face of the second portion. The first portion and second portion are configured to enclose the reference material such that the calibration standard is void free at an interface between the first material and the reference material and at an interface between the second material and the reference material.

### TECHNICAL FIELD

The present invention relates to reference standards for use in ultrasonic scanning tests and methods of making. More specifically, the present invention relates to a void free C-scan calibration standard for use with phase inversion detection systems and methods of making.

### BACKGROUND

One method of applying thin films of materials during manufacturing of integrated electronic circuits is sputter deposition, also known as sputtering. Sputtering includes forming a target of a material which is to be deposited, and providing the target as a negatively charged cathode proximate to a strong electric field. The electric field is used to ionize a low pressure inert gas and form a plasma. Positively charged ions in the plasma are accelerated by the electric field toward the negatively charged sputtering target. The ions impact the sputtering target, and thereby eject target material. The ejected target material is primarily in the form of atoms or groups of atoms, and can be used to deposit thin, uniform films on substrates placed in the vicinity of the target during the sputtering process.

Sputtering targets are manufactured to tight tolerances to ensure uniformity in the thickness and conformity of the layers formed by sputtering material from the targets. One problem that can occur during the manufacture of sputtering targets is formation of discontinuities within the sputter target material. Examples of discontinuities include voids, cracks, and changes in porosity throughout a material, as well as solid inclusions or impurities. Discontinuities in a sputtering target can lead to unipolar arcing during a sputtering process. Unipolar arcing can cause localized overheating and/or explosion of target material, and can thus decrease the uniformity and conformity of thin film deposition on a substrate. Additionally, if the discontinuities are inclusions or other impurities, sputtering from the discontinuities can result in particles of the impurities being deposited onto the substrate.

Because of the ever tightening tolerances for uniformity, purity, and conformity in sputtering targets, testing technologies which can distinguish homogeneous target materials from inhomogeneous target materials must be constantly improved. Among the techniques which are most useful for testing target materials are techniques which are nondestructive to the materials. In other words, techniques that evaluate the materials but still enable the materials to be used as starting materials and ultimately used as sputtering targets.

Nondestructive testing may be conducted using various non-invasive measurement techniques, such as ultrasonics and radiography to determine the integrity of a component, structure, or material without destroying the usefulness of the item. For example, nondestructive testing of products and structures, such as by ultrasound, may be used to detect discontinuities within the material and to measure the thickness of objects.

Ultrasound is an oscillating sound pressure wave with a frequency greater than the upper limit of the human hearing range. Ultrasound penetrates most solid material and can travel through the material without disturbing or altering it. Most metals, as well as plastics and composite materials, can be tested, inspected, and/or imaged with ultrasound. An acoustic scanner is one option for conducting a nondestructive test using ultrasound. An acoustic scanner uses very high or ultra-high frequency ultrasound to create images of the internal feature of the test object. An ultrasonic image can be used to identify the existence of discontinuities, measure their size, and identify their location.

Phase inversion imaging occurs when discontinuities cause changes in polarity or phase of the reflected signal. For example, when a material being tested contains discontinuities made of a material that differs greatly in acoustic impedance, the phase or polarity of the echo will reverse when the order of relative acoustic impedances is reversed (from low to high versus high to low). As used herein, the term “phase inversion” refers to a reversal in phase experienced when an incident sound wave is reflected back at the scanning probe from the target material.

The scanning probe can detect incident sound waves and provide data about the waves to a computer which processes this information and creates an image representing the internal structure of the material. The quality of any read-out image relies on the data processing and the computer program used to quantify the imaging signals. The read-out image may be compared to an image of a calibration standard to identity discontinuities and potentially one or more details of the discontinuities, such as the type of discontinuity, relative size, and distance below the surface. Thus, the accuracy of the calibration standard affects the ability and accuracy to which subsequent ultrasonic testing and inspection can be interpreted. An ultrasonic test, such as phase inversion based C-scan technique, can be used to non-destructively inspect an object for discontinuities such as voids or inclusions. Before C-scan software can be used in illustrating and interpreting ultrasonic testing data, the software must first be programmed or calibrated to distinguish between signals and interpret data by comparing it with known signal amplitudes from known discontinuities.

### SUMMARY

In some embodiments, the instant application discloses a reference standard for calibrating an ultrasonic scanning apparatus comprising a first portion comprising a first material, a first face, and a second face opposite the first face. The reference standard also has a second portion comprising a second material, a first face, and a second face opposite the first face. The second face of the second portion is adjacent the first face of the first portion and forms an interface. The reference standard also includes a reference material extending axially through the first face of the first portion and the second face of the second portion. The first portion and second portion are configured to enclose the reference material such that the calibration standard is void free at an interface between the first material and the reference material and at an interface between the second material and the reference material.

In some embodiments, the instant application discloses a method of forming a reference standard for calibrating ultrasonic scanning, comprising forming a puck from a first matrix material. The puck has a first face, a second face, a central axis extending between the first face and the second face, and openings extending in a direction parallel to the central axis. The method includes placing reference material within the openings, the reference material extending from the puck through the first face. The method includes heating and applying pressure to the puck in a direction perpendicular to the central axis of the puck such that the space surrounding the reference material is void free. The method also includes casting a second matrix material onto the puck such that the reference material is embedded within the first matrix material and second matrix material, and the space surrounding the reference material and the space between first face of the puck and the second matrix material are void free.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a perspective view of an exemplary ultrasonic scanning system.

FIG. 2 is a cross-sectional view of an inclusion-based reference standard, according to some embodiments.

FIG. 3 is a flow chart of an exemplary method for creating an inclusion-based reference standard.

FIG. 4 is a flow chart of an exemplary method for creating an inclusion-based reference standard.

FIG. 5 is a diagram of an exemplary casting system for formation of an inclusion-based reference standard.

### DETAILED DESCRIPTION

Described herein is a void free inclusion-based reference standard for use in non-destructive testing such as ultrasonic testing using phase inversion based C-scan. An exemplary method of forming a void free reference standard is also described. In some embodiments, the reference standard enables improved accuracy in interpreting or reading images of target objects. For example, the reference standard can include a known bulk material and/or contain known inclusions having known dimensions and at known locations or positions within the bulk material. In some examples, the reference standard can enable a non-destructive testing method of a target material to more accurately size and distinguish between voids and inclusions.

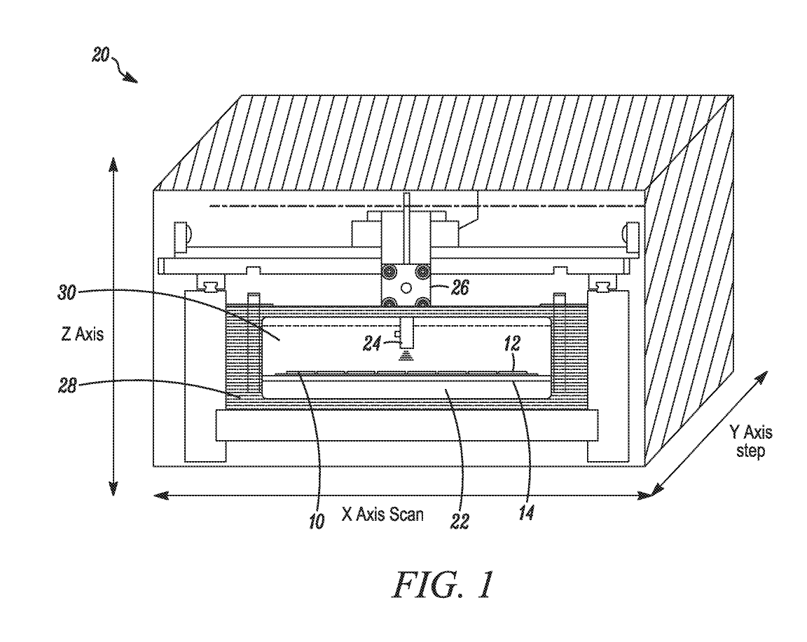

FIG. 1 is a perspective view of an example ultrasonic scanning device 20 that can be used to produce a C-scan of an object, such as a sputtering target material 10. In an exemplary method, the sputtering target material 10 is placed within a testing vessel 28 containing a liquid 30 such as water .e. de-ionized water) or oil. The sputtering target material 10 can be supported by a support structure 22 such that the sputtering target material 10 does not touch the bottom of the testing vessel 28.

In some embodiments, the sputtering target material 10 may be an ingot which may later be formed such as by compression, into a sputtering target shape. In some examples, the sputtering target material 10 may comprise a top surface 12 and a bottom surface 14 parallel to the top surface 12.

Once the sputtering target material 10 is immersed in the testing liquid 30, a transducer 24 is positioned within the testing liquid 30 above the surface of the sputtering target material 10. The transducer 24 irradiates the top surface 12 of the sputtering target material 10 with an ultrasonic pulse. Subsequently, the transducer 24 detects an echo reflected back from a feature such as a discontinuity within the sputtering target material 10. The transducer 24 converts the echo into an electrical signal which is processed for use in characterizing the sputtering target material 10. Specifically, the amplitude of the echo, as well as the time between the pulse and the echo are used to determine if discontinuities are present within the sputtering target material 10.

The transducer 24 can be mounted on a mechanical X-Y scanning unit 26 (also referred to as a C-scanner) which is in electrical communication with a controller (not shown), The controller is in data communication with a processor. The processor is also in data communication with a pulser/receiver that is coupled to the transducer 24. The controller can be programmed to induce the mechanical X-Y scanning unit 26 to move the transducer 24 in a raster-like step wise motion across the top surface 12 of the sputtering target material 10. Accordingly, a plurality of positions are defined across at least a portion of the top surface 12 of the sputtering target material 10. The transducer 24 is moved sequentially to each of the positions where it is triggered by the pulser/receiver to irradiate the entire sputtering target material 10 with ultrasound.

The transducer 24 detects echoes at the respective positions defined over the sputtering target material 10 surface and relays information about the detected echoes to the receiver. The receiver digitizes the information and sends it to the processor. The processor associates digitized signals received from the receiver with relative positions of the transducer 24 over the sputtering target material 10 surface, and analyzes the signals. The processor can comprise a commercially or otherwise available software package, such as, for example, Multiscan™ software available from Panametrics™, Inc.

Ultrasound C-scan imaging characterizes the signals reflected hack from the sputtering target material 10 and reconstructs images using image processing software. These images serve as visual representation of the internal condition of the structure and can be analyzed for distinctive patterns that indicate the presence of discontinuities such as inclusions or voids. In some embodiments, appropriate tuning of the device software results in effective C-scan images, allowing the determination of the position and, in some cases, of the shape and relative size of discontinuities.

Absorption and scattering of sound can be different for solid inclusions relative to other types of discontinuities in materials. Discontinuities without solid inclusions include voids, clusters of voids, or small cracks within sputtering targets. Such discontinuities can exhibit different shape and sound reflections or scattering and absorbance properties than discontinuities comprising solid inclusions that may be rigid.

In some embodiments, the method described herein can be used to differentiate between solid inclusions and other discontinuities in sputtering materials using phase information from returned ultrasonic pulses. It has been found that in some embodiments a pulse returned from a solid inclusion of higher acoustic impedance relative to the target material is reversed in phase (i.e., phase inversion) as compared to that returned from a discontinuity of lower acoustic impedance relative to the target material.

Phase inversion can enable discrimination of ultrasonic signals returned from lower acoustic impedance discontinuities, such as, for example, voids, entrapped gas bubbles, and flat bottom holes from signals returned from higher acoustic impedance discontinuities such as, for example, various solid inclusions. Phase analysis of the echoes can be accomplished by manual analysis of signals from specific discontinuities, or by automated signal processing techniques using, for example, computer software.

A computer processor can be programmed to show the phase reversal between a signal reflected from a void and an inclusion with a higher density than the matrix material. In some embodiments, an automated analysis can be programmed to allow identification of specific discontinuities by type (voids or solid inclusions) if it has been calibrated using previously identified discontinuities. A software program can be further calibrated to use a defined model based on solid inclusions to calculate the size (area) of the discontinuities identified as solid inclusions.

One method of calibrating a C-scan device is accomplished using a calibration standard. For example, the cross-sectional area of the calibration standard can be scanned with the C-scan device and the image produced by the read-out can be matched with the known discontinuities within the calibration standard. The returned signals from the read-out image can be correlated with the known discontinuities to compare the signal, the cross-sectional area of each discontinuity, and each discontinuity's distance from the scanner. After calibration, a C-scan device can be used to test objects containing unknown discontinuities at unknown depths. A calibration standard can also aid a user in determining the makeup of or categorizing a discontinuity as an inclusion or void.

Until now, phase inversion functionality has not been activated in ultrasonic detection systems. There is currently no calibration method for accurately sizing inclusions which may be present within a sputtering target material. Physical calibration standards for detecting inclusions are not commercially available and previous attempts to create a standard having known inclusions failed due to void formation around the inclusions. For this reason, a method of making a void free inclusion-based calibration standard is desired for calibrating the phase inversion technique. The inclusion calibration standard must contain known inclusions alone, and be void free at the interface between the bulk material and inclusions, specifically at an interface that is perpendicular to an incident ultrasonic testing signal.

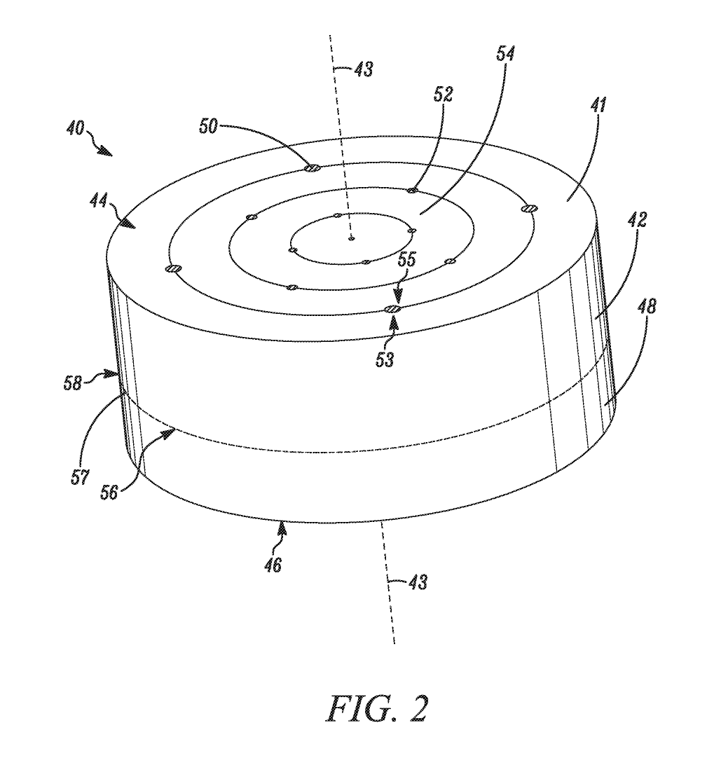

FIG. 2 contains a cross-sectional view of a calibration standard 40. In some embodiments, a calibration standard 40 is formed of a solid body 41 having a central axis 43 and reference fibers 50, 52, 54 embedded within the solid body 41. The solid body 41 contains no voids within the bulk material or around the reference fibers 50, 52, 54 such that the surfaces of the reference fibers 50, 52, 54 within the solid body 41 are fully wetted.

As used herein, “void” refers to a discontinuity in a bulk material greater than 180 microns in width, and more particularly, greater than 250 microns in width, which does not create a phase inversion echo in an ultrasonic C-scan. Thus, a void free calibration standard 40 does not contain one or more discontinuities in the bulk material in a size greater than 250 microns in width, and more particularly, greater than 180 microns in width, which do not create a phase inversion echo in a C-scan. The discontinuity may be gas or a combination of gas and a solid impurity or inclusion. For example, a void free calibration standard 40 is free of spaces or pockets of gas between any of the reference fibers 50, 52, 54 and the bulk material of the solid body 41, wherein the combined width of the reference fiber and the space is greater than 250 microns in width, and more particularly, greater than 180 microns in width, and wherein space and reference fiber does not create a phase inversion echo. As used herein, width refers to the largest distance that can be measured in a straight line between any two points within the shape being measured.

The solid body 41 as illustrated has a substantially cylindrical shape. However, the solid body 41 may be any possible shape. For example, the solid body 41 may be in the shape of a cube depending on the desired cross-sectional shape for the particular calibration standard 40. The solid body 41 has a first face 44 and a second face 46 perpendicular to the central axis 43. The first face 44 and second face 46 can be substantially planar to allow the solid body 41 to be scanned along the surface of either of the first or second faces 44, 46.

In some embodiments, the solid body 41 is formed from a first portion 48 and a second portion 41 The first portion 48 may optionally be constructed as a puck, The first portion or puck 48 generally has the same shape as the solid body 41 and has at least a first face 56 parallel to the first face 44 and second face 46 of the solid body 41. In some embodiments, the puck 48 contains at least a portion of the reference fibers 50, 52. 54 that are within the solid body 41.

The puck 48 may be joined to the second portion 42 of the solid body 41. For example, the puck 48 may have a first face 56, and the second portion 42 may have a first face 58 joined to the first face 56 of the puck 48. When the puck 48 and second portion 42 are joined to one another, the first and second faces 56, 58 form an interface 57. The second portion 42 is adjacent to and fully joined to the puck 48 with no voids within the interface 57 of the puck 48 and second portion 42.

In some embodiments, reference fibers 50, 52, 54 are artificial impurities contained within the solid body 41 to produce a predicted signal when the solid body 41 is scanned. The reference fibers 50, 52, 54 have an elongated shape and a known cross sectional area. The reference fibers 50, 52, 54 may vary in length, cross sectional shape, and/or cross sectional area. The reference fibers 50, 52, 54 extend parallel to the central axis 43 of the solid body 41 and can be placed at various locations radially about the central axis 43. Although only three reference fibers 50, 52, 54 are shown, any suitable number of reference fibers 50, 52, 54 may be included in the solid body 41

In some embodiments, the reference fibers 50, 52, 54 are fully enclosed within the solid body 41. That is, the bulk material of the solid body 41 covers the reference fibers 50, 52, 54 such that the reference fibers 50. 52, 54 are not exposed at the first surface 53 or the second surface 55. The reference fibers 50, 52, 54 extend a known distance along the length of the solid body 41 parallel to the central axis 43. Since each of the reference fibers 50, 52, 54 is created from a known material, the resulting image produced from a C-scan of the solid body 41 can be used to calibrate a C-scan device and software system. Additionally, since each of the reference fibers 50, 52, 54 extend a known distance along the central axis 43 of the solid body 41, the calibration standard 40 can also be used to calibrate C-scan software to determine locations of impurities within a material subjected to nondestructive scanning.

The solid body 41 fully encloses the reference fibers 50, 52, 54 within the bulk material. The reference fibers 50, 52, 54 are fully enclosed within the solid body 41 and the area surrounding the reference fibers 50. 52, 54 is void free.

Disclosed herein is a void free ultrasonic testing calibration standard 40. The void free ultrasonic calibration standard 40 is a single solid body 41 comprised of a bulk matrix material with reference fibers 50, 52, 54 embedded in the bulk matrix material. The solid body 41 contains no voids. The solid body is formed from a first portion 48 and a second portion 42. The reference fibers 50, 52, 54 extend through both the first portion 48 and the second portion 42.

The solid body 41 is comprised of a bulk matrix material defining a central axis 43. In some embodiments, the bulk matrix material is a metal or metal alloy. For example the bulk matrix material may be a metal or metal alloy used to form a sputtering target. Suitable materials for the bulk material also include plastics and ceramics. The bulk matrix material of the first portion 48 may be the same as the bulk matrix material of the second portion 42. In some embodiments, the reference fibers 50, 52, 54 are formed from material that creates an ultrasonic phase inversion echo. In some embodiments, the reference fibers 50, 52, 54 are formed from material configured such that a reflected echo of an ultrasonic wave subjected to the reference standard has a phase inversion. For example, reference fibers may be formed of aluminum oxide (alumina), silicon dioxide (silica), steel, iron, or other oxides or metals. The reference fibers 50, 52, 54 may be configured in the shape of an elongated rod with a length greater than the diameter. The reference fibers 50, 52, 54 are radially spaced around the central axis 43 of the solid body 41 and with the length of each reference fiber 50, 52, 54 parallel to the central axis 43 of the solid body 41. The reference fibers 50, 52, 54 may have a diameter of from about 0.005 inch to 0,060 inch and any diameter within this range. For example, the reference fibers 50, 52, 54 may have a diameter from 0.010 inch to 0.050 inch, from 0.020 inch to 0.040 inch, or from 0.025 to 0.035 inch, and any diameter in between.

The first portion or puck 48 contains a portion of the reference fibers 50, 52, 54. The reference fibers 50, 52, 56 have at least a first section embedded a first distance into the puck 48 through a first face 56 of the puck 48, and have at least a second section extending a second distance out of the first face 56 of the puck 48. The first portion 48 is void free and more specifically, the area surrounding the first section of the reference fibers 50, 52, 54 that are embedded in the puck 48 is void free.

The puck 48 may be joined to the second portion 42 with the first face 56 of the puck 48 adjacent to a first face 58 of the second portion 42. The plane where the first face 56 of the puck 48 and the first face 58 of the second portion 42 meet forms an interface 57 that is void free.

The second section of the reference fibers 50, 52, 54 that extends a second distance out of the first face 56 of the puck 48 may be embedded in the second portion 42 of the solid body 41. The reference fibers 50, 52, 54 thus extend from within the puck 48, through the interface 57 and extend a second distance into the second portion 42. The second portion 42 is void free, and more specifically, the area surrounding the second section of the reference fibers 50, 52, 54 that are embedded in the second portion 42 of the solid body 41 is void free.

Thus, the calibration standard 40 is formed of a single solid body 41 comprised of a first section or puck 48 and a second portion 42. The single solid body 41 encloses reference fibers 50, 52, 54 and is void free. The length and diameter of the reference fibers 50, 52, 54 are known and the reference fibers 50, 52, 54 extend a known distance along the central axis 43 of the solid body 41.

The solid body 41 can be scanned in a direction parallel to the central axis 43 using an ultrasonic C-scan device, The ultrasonic C-scan device detects the reference fibers 50, 52, 54 by analyzing a phase inversion echo of the ultrasonic signal. The phase inversion echo is used by the C-scan device to create an image of the solid body 41 and the reference fibers 50, 52, 54 contained within the solid body 41. The image created can be compared with the information known about the reference fibers 50, 52, 54 such as composition, size, and location, and used to calibrate the C-scan device. The calibration standard 40 can thus be used to calibrate ultrasonic C-scanners for nondestructive testing of sputtering target materials.

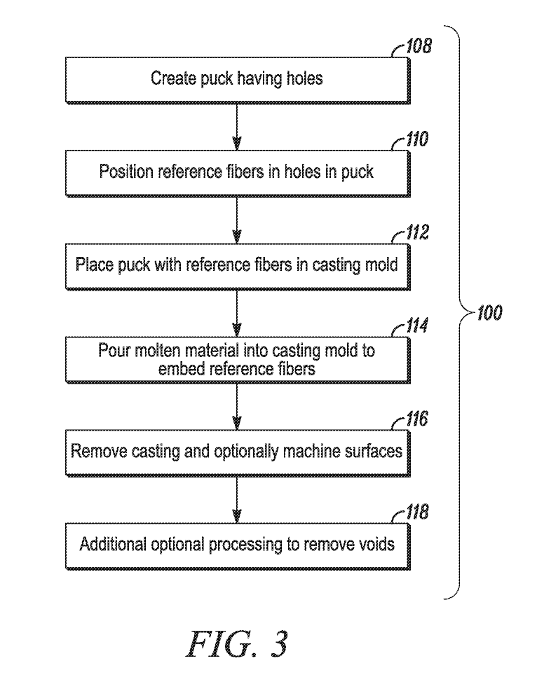

As shown in FIG. 3, one method of creating a calibration standard is illustrated using a flow chart depicting exemplary steps. The method 100 for creating the calibration standard includes creating a puck with holes (step 108), For a calibration standard in which the bulk material is a metal such as aluminum or copper, step 108 may include casting the molten metallic material. For calibration standards in which the bulk material is a plastic, step 108 may include injection molding.

Holes may be formed in the puck after the puck is created or may be formed simultaneously when creating the puck. For example, holes may be formed in the puck by drilling or boring into the puck. Alternatively, the puck may be cast or molded with holes.

Reference fibers are positioned within the holes of the puck (step 110). One reference fiber is positioned within each hole of the puck (step 110). The reference fibers may be oriented parallel to the central axis of the puck such that length of the reference fiber is parallel to the central axis of the puck.

In step 112, the puck containing the reference fibers is then placed within a casting mold. The casting mold is configured to retain the puck within the casting mold with the reference fibers oriented parallel to a central axis of the casting mold. Once the puck is placed within the casting mold, molten bulk material that is the same material as the bulk material of the puck is poured into the casting mold (step 114). A sufficient amount of molten bulk material is provided to fully wet the entire face of the puck and to fully embed the reference fibers. For example, the molten bulk material may till the casting mold at least to cover the tops of the reference fibers. To create a calibration standard with reference fibers a certain distance from the puller/receiver, the molten bulk material is poured until the depth of the molten material as measured from the top of the solid body to the top of the fibers corresponds to a desired distance. After the molten material has been poured, it is allowed to cool and solidify, forming the second portion of the solid body joined to the puck and enclosing the reference fibers.

Once the molten material has been poured and solidified, the puck containing the reference fibers and the cast molten material joined to the puck collectively make up a single solid body. The single solid body is removed from the casting chamber and the surfaces of the solid body may optionally be machined or etched in step 116 to remove any impurities from the surface and/or to smooth the surfaces of the solid body.

The solid body may optionally undergo further additional processing in step 118 to ensure that any voids that remain within the solid body are removed. For example, the solid body may be subjected to a hot isotactic pressing (HIP) step. In a HIP step, the solid body is heated until it is pliable. The solid body is then compressed using either air or machine pressure to remove any voids that may remain within the solid body material. It is particularly desirable to remove any voids that may remain around the reference fibers now embedded within the bulk material of the solid body.

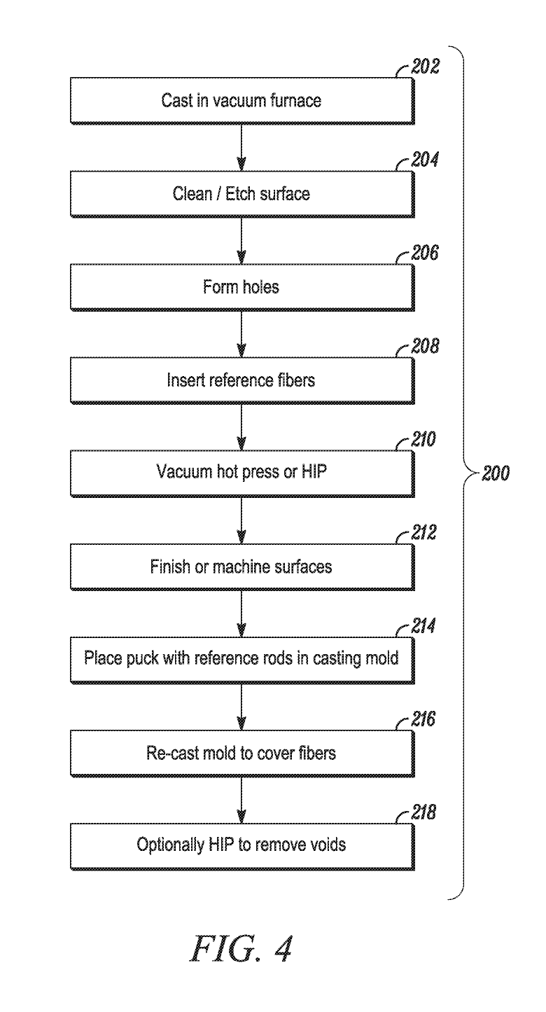

As illustrated in FIG. 4, a method of creating a calibration standard can be applied in particular to calibration standards wherein the bulk material is a metal or metal alloys. The method shown in FIG. 4 is particularly suited to creating a calibration standard out of materials that form sputtering targets. For example, the method outlined in the flow diagram of FIG. 4 is particularly suited to forming calibration standards out of aluminum or copper. In some embodiments, the methods disclosed herein may be used to form calibration standards out of ceramic, silicon, polymeric material, graphite, steel, iron, aluminum, copper, titanium, tungsten, tantalum, gold, manganese, and alloys and combinations of these materials. The method 200 of FIG. 4 can be used to create standards for calibrating ultrasonic scanning equipment that uses an echo phase inversion detection based C-scan technique to determine the location and characteristics of voids and inclusions in a sputtering target material.

In the sputtering target calibration standard creation method 200, a molten metal or metal alloy is first cast in a vacuum furnace (step 202). The vacuum furnace is used to cast high purity aluminum or copper. The high purity aluminum or copper is cast into a mold within the vacuum furnace. The molten aluminum or copper is cast to form a first portion of the solid body or puck. Once the puck has been cast and solidified, the surfaces of the puck undergo a cleaning, in step 204. In the cleaning step 204, the surfaces of the puck are cleaned, machined, polished, or etched to form a smooth, pure, cohesive surface all around the puck. The cleaning step 204 also serves to remove any oxides or other impurities that may be on the surface of the puck.

After the puck has been cast and cleaned, holes are formed into a surface of the puck (step 206). For example, if the puck has a cylindrical shape, holes are formed into one of the flat faces of the cylinder and into the body of the cylinder. One method of forming holes in the puck is by drilling. Once holes are formed in the face of the cylinder, reference fibers are inserted in the holes (step 208). The reference fibers comprise material that may be found within sputtering target material. For example, for sputtering target material calibration standards, the reference fibers may comprise any of aluminum oxide, silicon oxide, silicon dioxide, graphite, and other common casting inclusions.

Once the reference fibers are inserted within the holes, the aluminum or copper puck undergoes a compression step such as a vacuum hot press or HIP step 210 to remove any voids that may remain in the puck or spaces that may be between the surfaces of the reference fibers and the bulk material of the puck. The vacuum hot press or HIP step 210 should be carried out long enough to ensure that the surfaces of the reference fibers are fully wetted by the bulk material of the puck with no voids surrounding the reference fibers. Following the compression step, the aluminum or copper puck undergoes a finishing or machining step 212 to remove any impurities or oxides that may have deposited on the surface of the puck.

In step 214, the finished puck containing the reference fibers is placed into a casting mold. The casting mold should be selected to fully enclose the sides of the puck with minimal spacing between the sides of the puck and the inside surface of the casting mold. The puck should be oriented with the reference fibers extending upward toward the top of the casting mold. In step 216, the casting mold is then re-cast or filled with molten aluminum or copper, depending on the material of the calibration standard. If an aluminum calibration standard is being made, an aluminum puck is placed into the casting mold, and molten aluminum should be added to the casting chamber to fully wet the surface of the aluminum puck facing upward, and to a level higher than the top of the reference fibers.

Molten aluminum or copper may be added to the casting mold up to a level corresponding to the distance the reference fibers should be from the puller/receiver when the calibration standard undergoes ultrasonic testing. The re-cast aluminum or copper is then allowed to cool and solidify inside the casting chamber to form a solid aluminum or copper body joined to the puck and enclosing the reference fibers. This solid aluminum or copper body comprises the calibration standard. The calibration standard may undergo an additional processing, in step 218, such as HIP to remove any remaining voids around the reference fibers. Using the method described herein, a calibration standard is created that can be used to calibrate ultrasonic C-scan equipment and software.

In some embodiments, the calibration standard is formed from the same or substantially similar bulk material as will be ultrasonically tested. For example, the bulk material of the calibration standard may be aluminum where the calibration standard is used to calibrate ultrasonic C-scan systems for testing aluminum ingots or materials used to form sputtering targets. However, the methods herein are not meant to be limited to the materials described here and instead are to be understood as capable of being applied to a wide variety of materials.

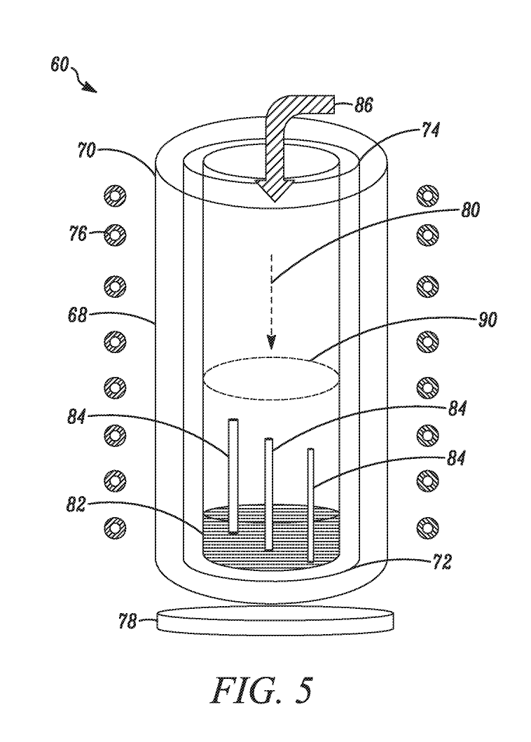

FIG. 5 shows an embodiment of a casting system 60 for forming a calibration standard in which a bulk material 86 may be aluminum and/or aluminum alloys. In some embodiments, a casting system 60 can be used in conjunction with the methods described herein to form a calibration standard.

In some embodiments, an aluminum puck 82 is vacuum cast to form a solid three dimensional body. Holes are created in the puck 82 that extend though a first face 44 of the puck 82 and into the body of the puck 82. Once the holes are created in the puck 82, reference fibers 84 can be placed within each hole. The reference fibers 84 may extend a second distance out from the puck in a direction parallel to an axial direction 80 of the puck 82. The axial direction 80 of the puck 82 and calibration standard is illustrated in FIG. 5 by the arrow 80.

As illustrated in FIG. 5, in some embodiments, the reference fibers 84 are the same length but are placed at various distances into the puck 82. In some embodiments, the reference fibers 84 are each of a different length. The location of each reference fiber 84 along the axial direction 80 of the calibration standard correlates to a distance that each reference fiber 84 lies from the first face 44 when the calibration standard is scanned from one of its end faces. Once each reference fiber 84 is placed within the puck 82, the puck 82 can be subjected to further processing to remove any gaps that may exist between each reference fiber 84, and the side of each hole. In some embodiments, the puck 82 is subject to hot isotactic pressing (“HIP”) to remove any voids or gaps between the reference fibers 84 and the holes in the puck 82.

FIG. 5 illustrates an example casting system 60 that can be used for further processing the puck 82 into a calibration standard according to some embodiments. In some embodiments, a casting system 60 that can be for further processing the puck 82 into a calibration standard comprises a casting mold 68 having a bottom 72, a top 74 and sides 70 extending between the top 74 and bottom 72. The sides 70 of the casting mold 68 may be surrounded by a heating element 76 such as heating coils. In some embodiments, the casting mold 68 may rest on a graphite plate 78 that holds the casting mold 68 in place during the casting process. The cross sectional area of the casting mold 68 should correspond to the cross sectional area of the puck 82 such that there are minimal gaps between the sides of the puck 82 when it is positioned within the casting mold 68.

The puck 82 containing the reference fibers 84 is positioned at the bottom 72 of the casting mold 68. The puck 82 is positioned within the casting mold 68 with the reference fibers 84 facing upwards into the casting mold 68. After the puck 82 is in position, additional amounts of bulk material 86 is provided into the casting mold 68.

The additional bulk material 86 is the same material that comprises the puck 82. In some embodiments, the additional bulk material 86 may be poured in a molten or liquid form. The liquid or molten additional bulk material 86 is poured until the reference fibers 84 are completely embedded in the additional bulk material 86. Thus the additional bulk material 86 may be added until the level of the molten additional bulk material 86 is higher than the top of the highest reference fiber 84, as shown by the dashed line 90. The additional bulk material 86 should fully embed the reference fibers 84 in the additional bulk material 86. For example, the additional bulk material 86 should fully wet the surfaces of the reference fibers 84.

In some embodiments, the additional bulk material 86 may be added until it fills a desired portion of the casting mold 68 above the reference fibers 84 to form a second portion. As shown by the line 90, the additional bulk material 86 may fill the casting mold 68 to a level height that corresponds to a particular distance each reference fiber should be located from one end of the calibration standard. The level of the additional bulk material 86 added to the casting mold 68 thus corresponds to the distance the reference fibers 84 will be located from the first face 44 (shown in FIG. 2).

The additional bulk material 86 is allowed to solidify within the casting mold 68 to form a complete solid body comprised of a puck 82 adjacent to the second portion. The solid body completely embeds the reference fibers 84. Thus the puck 82 and the additional second portion are adjacent to each other with no voids in between them. The combination of the puck 82 and the second portion also fully enclose the reference fibers 84, thus creating a calibration standard comprising a single solid body with reference fibers 84 of known composition contained within and at a known distance from each end of the calibration standard.

The calibration standard can be removed from the casting system 60 and be subjected to a further heating and pressing step to ensure that any voids or gaps that may exist between the reference fibers 84 and the calibration standard material are removed.

Sputtering targets are formed from a sputtering target material such as a metal, metal alloy, or combinations thereof, for example by pressing the sputtering target material in the form of an ingot into the shape of a sputtering target. Exemplary sputtering target materials include but are not limited to aluminum, copper, titanium, tungsten, tantalum, gold, manganese, and alloys and combinations thereof n sonic examples, aluminum or copper is the most prevalent constituent in the sputtering target material. For example, some sputtering targets may be formed of a sputtering target material containing at least 90% by weight aluminum or copper.

In addition to metallic constituents, the sputtering target material may include small amounts of impurities, such as, for example, silicon dioxide, aluminum oxide, carbon, hydrogen, and/or air. Impurities can be in the form of inclusions (i.e. solid impurities) or voids (i.e. gaseous impurities), Such impurities represent one type of discontinuity which can be present in a target material. Although the methods described in the instant disclosure are described with respect to metallic materials, the methods may also be used for non-metallic materials. For example, the described methodology may be used to create calibration standards for testing nonmetallic target materials, such as, for example, ceramic or polymeric materials.

A C-scan technique is often used as a nondestructive test for determining the presence of discontinuities in a sputtering target material. It is essential that the C-scan be accurately calibrated so that any discontinuities found within the bulk of the inspected material can be properly interpreted and sized. One technique for calibrating a C-scan device is to create a calibration standard comprising a known material, with known discontinuities, and at known locations. The calibration standard can be scanned with C-scan and the resulting test of the calibration standard can be used as a reference to calibrate the C-scan software to interpret other test results. Thus a calibration standard is created in order to have a known material, containing known reference discontinuities such as inclusions, at a known depth/distance within a known material.

In some embodiments, since the calibration standard will be used to compare C-scan data of a sputtering target material, a calibration standard is formed of the same material as the sputtering targets on which the C-scan testing method will be used. For example, the calibration may comprise any material that will be used to create a sputtering target. Thus, the calibration standard may comprise aluminum, copper, titanium, tungsten, tantalum, gold, manganese, and alloys and combinations thereof.

The reference fiber material that is used to create the inclusions should be selected from material that could possibly end up as an impurity in the material that is being tested. One possible impurity that can be found in cast aluminum is aluminum oxide. Thus a calibration standard that is being used to calibrate a C-scan system and/or software to detect the presence of aluminum oxide within aluminum should incorporate at least one reference fiber comprised of aluminum oxide. In alternative embodiments, a reference fiber may comprise any material that may be found as an impurity in aluminum and may include, for example, silicon dioxide, steel, iron, or other oxides or metals.

Since the calibration standard is created to test the presence of discontinuities such as inclusions or voids, to create an accurate baseline reading when using the calibration standard, the calibration standard should comprise a reference material that is as pure as can possibly be obtained. For example a calibration standard that is being created for testing aluminum sputtering targets should comprise aluminum in as high a purity as can be obtained. In some embodiments, reference material comprising 5N9 or 6N9 purity may be used. Undesired or uncontrolled discontinuities in the calibration standard may affect the test readings during calibration, and may lead to an improper calibration of the C-scan equipment and/or software. Thus it is essential that when the calibration standard is formed, any voids within the calibration standard are removed.

In particular, voids that are located at an interface between the calibration standard material and the reference material should be removed as these will alter the acoustic response from the cross-sectional area of a discontinuity. Additionally, because a void will often have a different density than a solid inclusion, a void can create an inaccurate reading in a phase inversion C-scan test. Using the methods described herein, it has been shown that it is possible to create a. calibration standard while eliminating voids to a level lower than the detection limit of the C-scan test method used.

### EXAMPLES

The following non-limiting examples illustrate various features and characteristics of the present invention, which is not to be construed as limited thereto.

In one example, a method for creating a precision calibration standard for measuring inclusions has been proven. This method has been shown to be capable of embedding a wide variety of inclusion types with varying wettability in different metallic systems, and can be used for a variety of materials.

First, a cylindrical puck 4 inches in diameter and 2 inches deep was cast in a vacuum furnace. Next, the puck was removed from the furnace and the surfaces of the puck were machined and etched to remove oxide from the surfaces.

Holes were then drilled into the face of the puck. The holes were 0.03 inches in diameter and 0.25 inches, 0.5 inches, and 0.625 inches deep. However, the depth of each hole may vary depending on the overall size of the calibration standard to be used. Alumina fibers 0.010 inch, 0.020 inch, 0.030 inch, and 0.040 inch in diameter were inserted into the holes. The alumina fibers were each of a different length so that when each fiber was inserted, the remaining portion of each fiber stuck out from the face of the aluminum puck at a different height. The puck was then heated and subjected to hot isostatic pressing (“HIP”) from the sides. The hot isostatic pressing was performed to remove any voids that may exist in the interface between the fibers and the aluminum.

Additional aluminum was then cast onto the mold containing the aluminum puck containing the aluminum fibers which are oriented facing the top of the casting mold. The puck was then removed from the casting mold. The surfaces of the cast calibration standard were then machined and etched to remove oxides on the surface. Hot isostatic pressing was conducted once more to close all remaining voids around the fibers. Vacuum hot pressing can also be used as an alternative method for removing the voids around the fibers.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

1.-10. (canceled)

11. A reference standard for calibrating an ultrasonic scanning apparatus, comprising:
a first portion comprising a first material and having a first face and a second face opposite the first face;
a second portion comprising a second material and having a first face and a second face opposite the first face, the second face of the second portion adjacent the first face of the first portion and forming an interface;
a reference material extending axially through the first face of the first portion and through the second face of the second portion;
wherein the first portion and second portion are configured to enclose the reference material such that the calibration standard is void free at an interface between the first material and the reference material and at an interface between the second material and the reference material.

12. The reference standard of claim 11, wherein the first material comprises at least one of ceramic, silicon, polymeric material, graphite, steel, iron, aluminum, copper, titanium, tungsten, tantalum, gold, manganese, and alloys and combinations thereof.

13. The reference standard of claim 11, wherein the first material and second material comprise aluminum, copper, or titanium as the primary constituent.

14. The reference standard of claim 11, wherein the second material is the same as the first material.

15. The reference standard of claim 11, wherein the reference material comprises at least one of alumina, silica, steel, and combinations thereof.

16. The reference standard of claim 11, wherein the reference material is more dense than the first material and the second material.

17. The reference standard of claim 11, wherein the reference material is less dense than the first material and the second material.

18. The reference standard of claim 11, and further comprising a second reference material extending axially between the first face of the first portion to the second face of the second portion, wherein the second reference material extends a different distance into the first portion than the reference material.

19. The reference standard of claim 11, further comprising a first plane, and a central axis, wherein the first face and second face of the first portion and the first face and second face of the second portion are parallel to the first plane, the central axis is in a direction normal to the first plane, and the reference material extends parallel to the central axis through the first face of the first portion and extends through the second face of the second portion.

20. The reference standard of claim 11, wherein the reference material causes ultrasonic echo phase inversion when exposed to an ultrasonic wave.

21. The reference standard of claim 11, wherein the reference standard does not contain a discontinuity having a width greater than 180 microns and that does not create a phase inversion echo.

22. A method of forming a reference standard for calibrating ultrasonic scanning, comprising:
forming a puck from a first matrix material, the puck having a first face, a second face, a central axis extending between the first face and the second face, and openings extending in a direction parallel to the central axis;
placing reference material within the openings, the reference material extending from the puck through the first face;
heating and applying pressure to the puck in a direction perpendicular to the central axis of the puck such that the space surrounding the reference material is void free;
casting a second matrix material onto the puck such that the reference material is embedded within the first matrix material and second matrix material, and the space surrounding the reference material and the space between first face of the puck and the second matrix material are void free.

23. The method of claim 22, wherein the first matrix material comprises at least one of ceramic, silicon, polymeric material, graphite, steel, iron, aluminum, copper, titanium, tungsten, tantalum, gold, manganese, and alloys and combinations thereof.

24. The method of claim 22, wherein the first matrix material and second matrix material comprise aluminum, copper, or titanium as the primary constituent.

25. The method of claim 22, wherein the second matrix material is the same as the first matrix material.

26. The method of claim 22, wherein the reference material comprises at least one of alumina, silica, steel, and combinations thereof.

27. The method of claim 22, wherein the reference material comprises material that is more dense than the first matrix material and second matrix material.

28. The method of claim 22, wherein the reference material comprises material that is less dense than the first matrix material and second matrix material.

29. The method of claim 22, wherein the reference material comprises material that causes an ultrasonic echo signal to undergo phase inversion when exposed to an ultrasonic wave.

30. The method of claim 22, wherein the reference standard does not contain a discontinuity with a width greater than 180 microns and that does not create a phase inversion echo.
